(19) United States
(12) Patent Application Publication
(10) Pub. No.: US 2012/0261148 A1
(43) Pub. Date: Oct. 18, 2012

(54) Machete rake

(75) Inventor: Feliks Sukhovitsky, Redwood City, CA (US)

(73) Assignee: Feliks Sukhovitsky, Emerald Hills, CA (US)

(21) Appl. No.: 13/136,411

(22) Filed: Aug. 1, 2011

Related U.S. Application Data
(60) Provisional application No. 61/516,728, filed on Apr. 7, 2011.

(51) Int. Cl. A01B 1/16; A01B 1/12; A01B 1/22; A01B 1/10

(52) U.S. Cl. 172/375; 172/378

(57) ABSTRACT

A gardening tool described as a rake with the ability to cut through vegetation thus allowing easier removal and collection of unwanted weeds. The cutting rake gardening tool comprises a regular or ergonomically reworked rake handle, and a special rake part secured to the handle. The rake part incorporates a cutting plane and is designed in a way that it can cut, pull, and collect unwonted vegetation in one motion, minimizing physical stress of a person using the tool and the method of removing weeds. The cutting rake gardening tool operation is secured with a built-in safety device.

### FIELD OF THE INVENTION

The filed of the invention is gardening tools for removing weeds. In a preferred embodiment, the weeds are removed from decorative grass.

### SUMMARY OF THE INVENTION

The cutting rake gardening tool comprises a regular rake handle and a cutting rake part secured to the handle. The cutting rake part has a handle mounting plane and a surface engageable plane for weeds removing. A blade represents the surface engageable portion with a plurality of teeth sharpened in a specific manner. In an embodiment of the invention, the surface engageable portion further comprises a means for gripping the weeds so that after the blade cuts the weed the gripping portion grips the weeds so they can be removed from the surface area. The cutting rake part is secured to the handle in a manner so that pulling the handle along the handle axis while the surface engageable portion is in engagement with the surface, from which weeds are to be removed, causes the blade portion to remove the weeds. In a preferred embodiment, the weeds are removed without cutting the decorative grass.

Another aspect of the present invention is a method of removing unwanted weeds from the area that has mixed vegetation of decorative grass and weeds. The method comprises providing a cutting rake gardening tool as shown. The method further comprises placing the surface engageable portion in engagement with the surface, and pulling the handle part generally along the handle axis while maintaining engagement of the surface engageable portion with vegetation surface to cause the blade portion to engage the unwanted weeds and pull them from the area without cutting or pulling the decorative grass.

Among the several objects and features of the present invention may be noted: the provision of an improved weeds/grass cutting rake gardening tool for removing unwanted weeds/grass; the provision of cutting rake gardening tool with a built-in safety device; the provision of such a tool and a method for using the tool which removes unwanted weeds/grass safely, quickly, and effectively; and the provision of a gardening tool and a method which minimizes physical stress on a person using the tool or method to remove unwanted weeds/grass.

### BRIEF DESCRIPTION OF THE DRAWINGS

FIG. 1A is a side elevation view of a cutting rake gardening tool of the present invention.

FIG. 1B is a side elevation view of the cutting rake gardening tool variation (1^{st} embodiment)

FIG. 1C is a side elevation view of the cutting rake gardening tool variation (2^{nd} embodiment)

FIG. 1D is a side elevation view of the cutting rake gardening tool variation (2^{nd} embodiment)

FIG. 1E is a side elevation view of the cutting rake gardening tool variation (1^{st} embodiment)

FIG. 1F is a front-elevation view of the cutting rake gardening tool of the second embodiment.

FIG. 2 is a front-elevation view of the cutting rake gardening tool of FIG. 1A.

FIG. 3 is a fragmented top plan view of the blade.

FIG. 4 is a side elevation view of a third embodiment of the cutting rake gardening tool of the invention and also shows a fragmented variation of top plan view of the blade.

FIG. 4A is another fragmented variation top plan view of the blade.

FIG. 4B is a side elevation view of a third embodiment of the cutting rake gardening tool of the invention that shows a handle design variation of the cutting rake gardening tool.

### DETAILED DESCRIPTION OF THE INVENTION

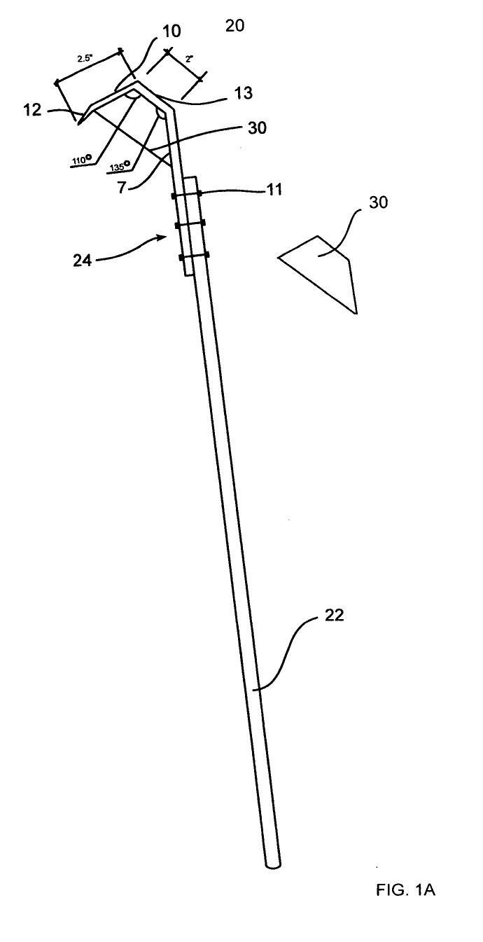

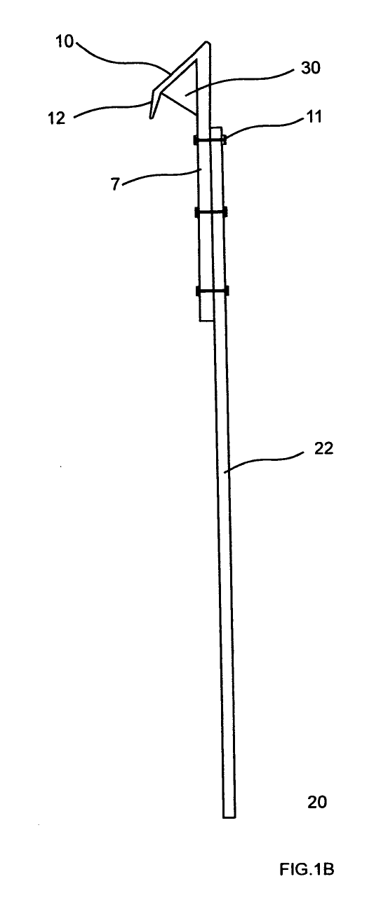

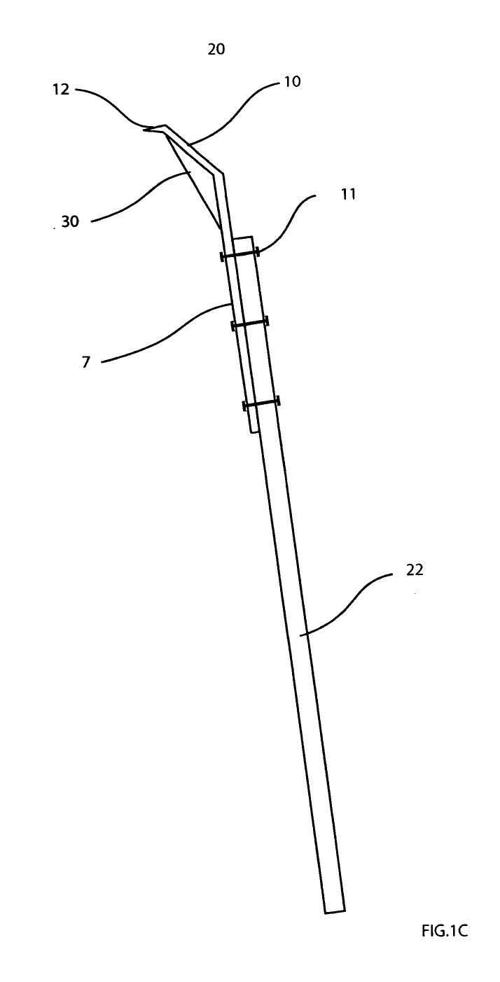

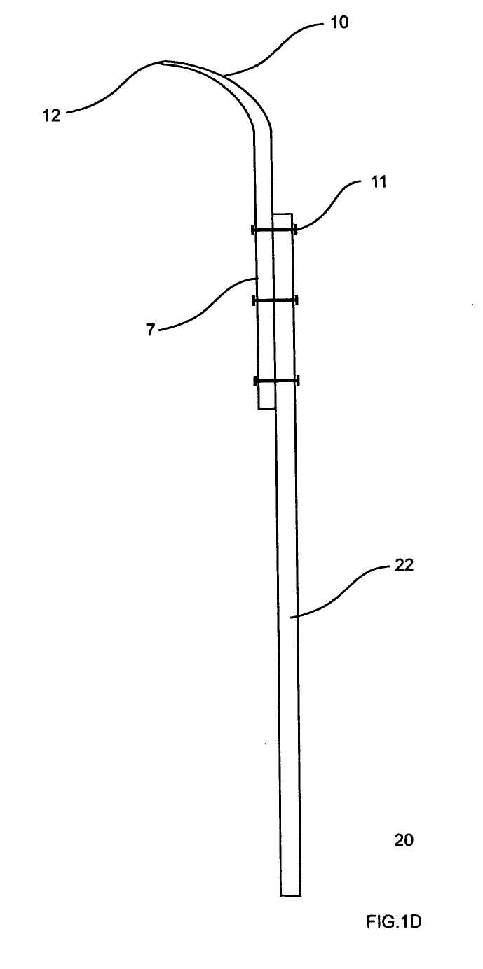

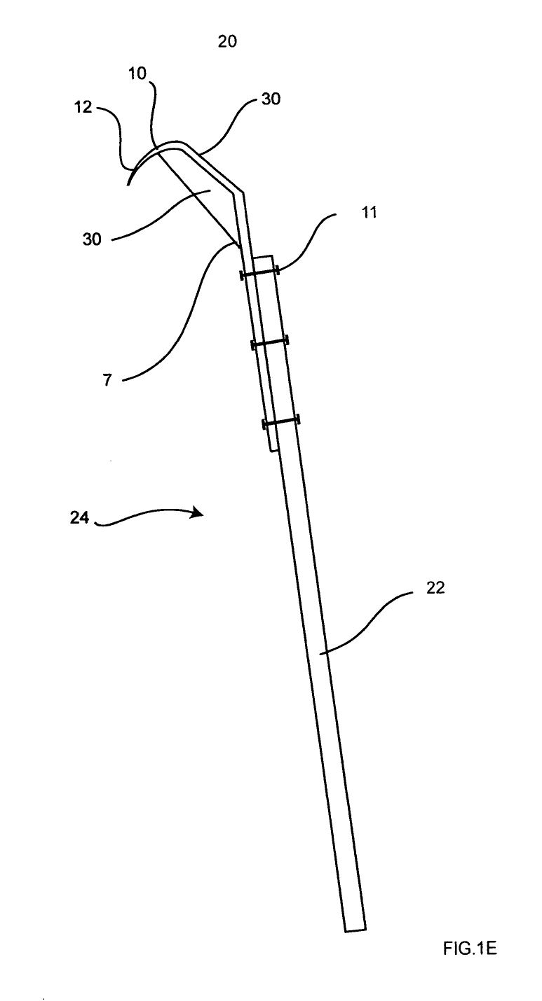

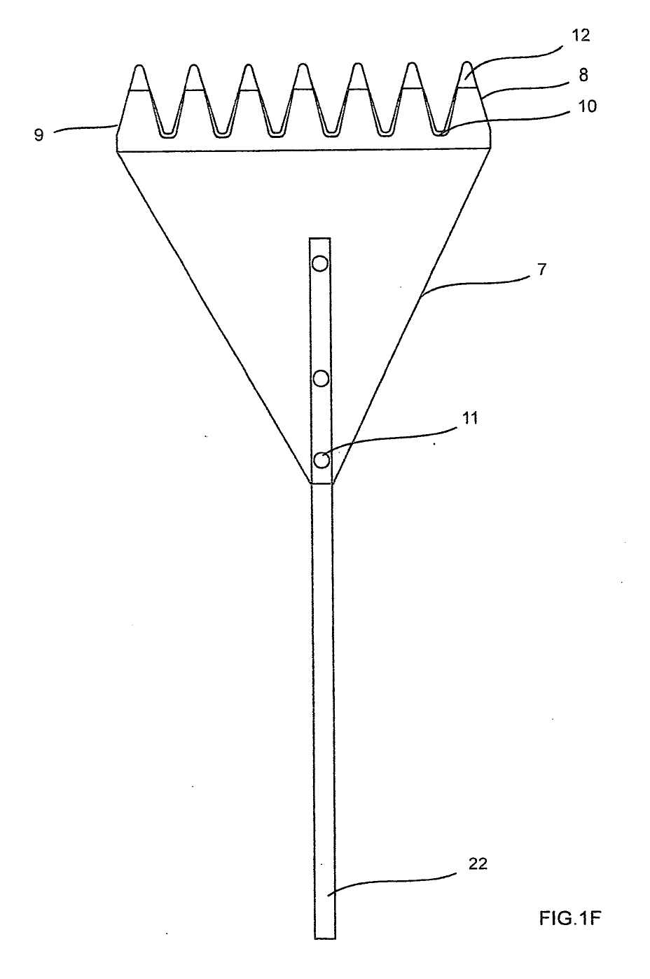

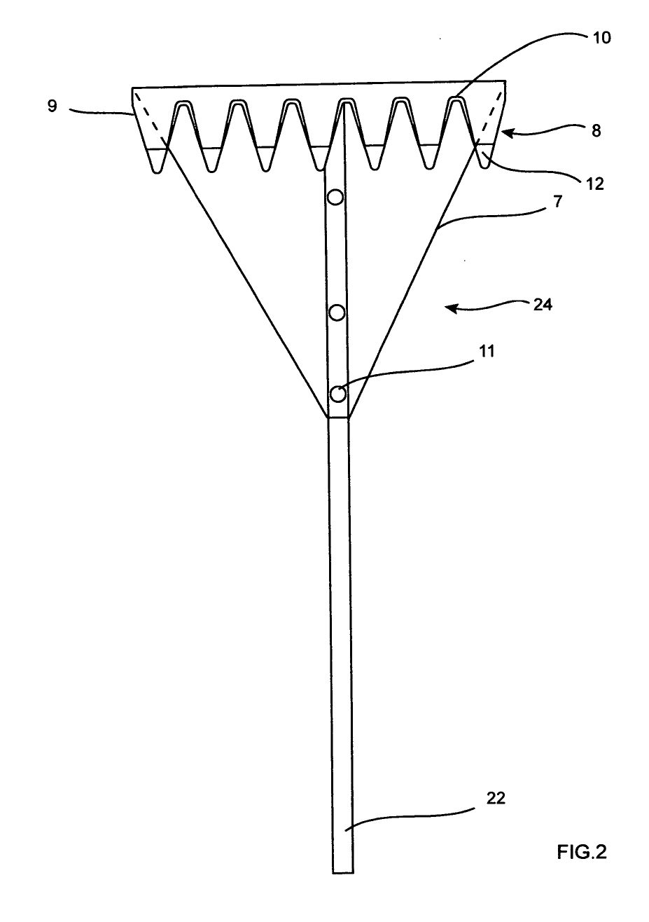

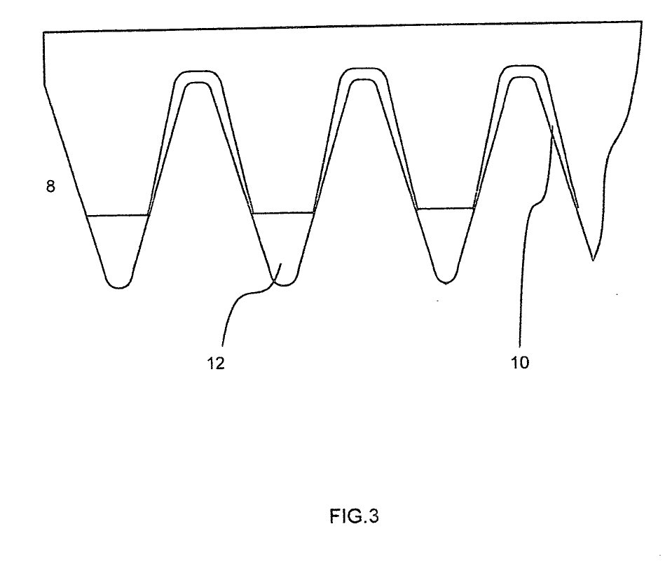

Referring first to FIGS. 1-3 of the drawings, a gardening tool of the present invention is generally indicated by reference numeral 20. The gardening tool 20 is adapted to be used with a grassy surface (not shown) such as lawn for removing the unwanted weeds from the lawn. The gardening tool comprises a handle part, indicated at 22, and a cutting rake part, indicated at 24. The handle 22 is preferably sized and shaped as a traditional but ergonomically re-worked rake handle to be comfortably held by user's hand.

The cutting rake part is attached to the handle of the rake. The cutting rake part consists of a single blade bent longitudinally to form a triangular mounting flange 7 and a cutter bar 8. The cutting rake part may be made from any suitable material, including, for example, metals, plastic, composites, and the like. The cutter bar 8 is shaped into V-shaped teeth 9 that have inside cutting edges 10 and outside dull edges 12. Plane 7 and plane 8 stand at obtuse angles to each other so that when the flange 7 is mounted to the handle 22 and the rake handle is held in the usual inclined position for raking purposes, the cutter bar 8 will project forwardly in a substantially horizontal position. Plane 7 and bent inward dull parts 12 form a scooping plane 13 between them. The mounting flange 7 is secured to the handle by means of bolts and nuts 11, rivets, or other suitable means. Dull parts 12 of the teeth raw are bent inward for safety and to facilitate sharp surfaces of the blade sliding along the lawn rather than digging into the dirt.

In second embodiment, the angle between plane 10 and plane 13 is modified so that the rake can be worked by pushing forward instead of pulling back.

The shape of the cutting edges 10 of the teeth 9 may be varied. Shapes of the teeth may be varied and include, for example, rounded or sharp angles. The shape of the cutting edges may also be varied, and can include, for example, rounded or sharp angles.

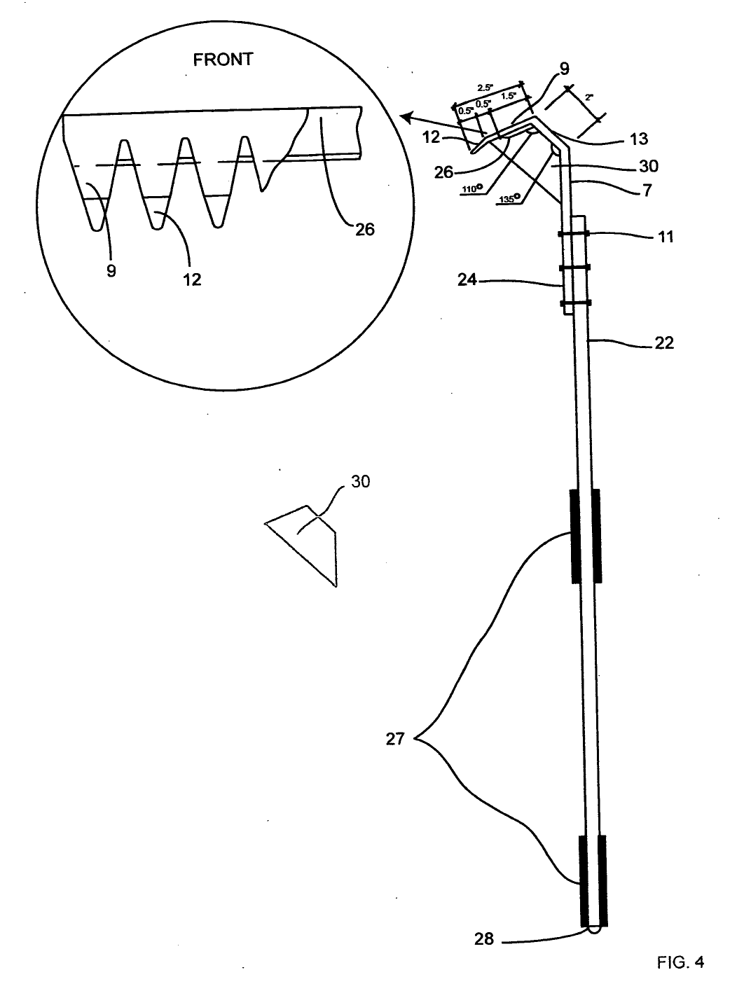

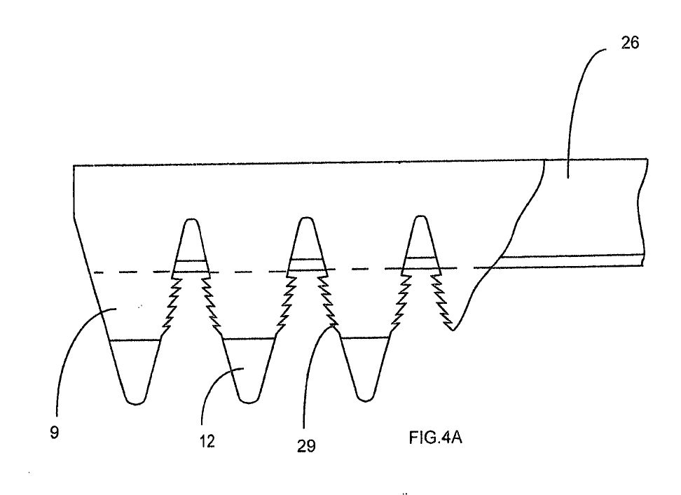

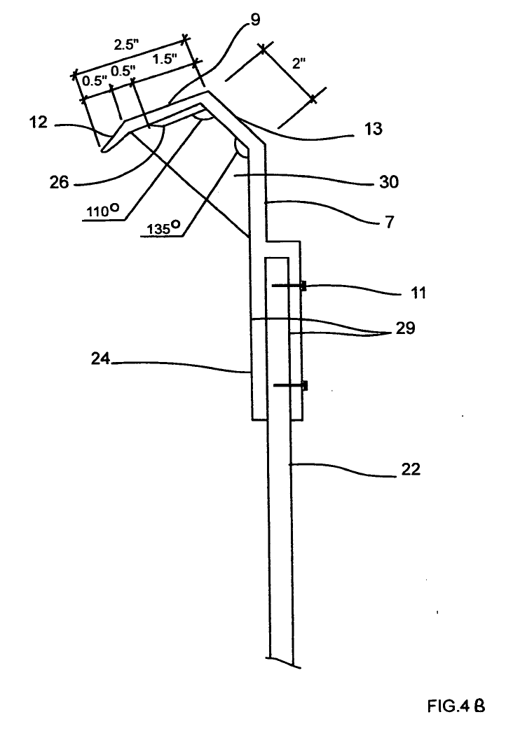

Third embodiment is referring to FIG. 4 of the drawings, a gardening tool of the present invention is generally indicated by reference numeral 20. The gardening tool 20 is adapted to be used with a grassy surface (not shown) such as lawn for removing the unwanted weeds from the lawn. The gardening tool comprises a handle part, indicated at 22, and a cutting rake part, indicated at 24.

Handle 22 is preferably sized and shaped as a traditional ergonomically re-worked rake handle to be comfortably held by user's hand. The cutting rake part 24 is bolted on the handle part 22 of the of the rake tool 20.

The cutting rake part 24 comprises a single molded form, made of plastic, resin, fiber composite, metal or other suitable material. Part 24 comprises the following planes: a triangular mounting flange 7 and part 13 (scooping plane), part 9 (V-shaped teeth) and part 12 (the ends of the teeth are bent inward for safety and to avoid digging into the surface being weeded). FIG. 4A shows that V-shaped teeth could also be equipped with corrugated edges on the sides for better gripping of the weeds. Cutting blade 26 is a straight razor blade, sharpened on one side that is mounted on top of plane 9 alone the base of plane 13. The sharp edge of the blade 26 is exposed between a row of teeth 9. Cutting blade 26 can be permanently attached to plane 9 or it can be removable or replaceable.

Gripping handles 27 can also be mounted on the handle part 22 for better gripping and/or for comfort. Hanging loop 28 allows easy storage and carrying. FIG. 4B shows that monolith round plastic enclosure 29 can be used to support the handle 22. A mounting flange 7 may be attached to the handle. In some embodiments, the mounting flange 7 is attached by bolts and nuts, screws, or rivets.

These tools are designed to cut, collect and dispose of weeds in one motion.

The invention has been described in detail with reference to specific embodiments thereof. However, it will be appreciated that those skilled in the art, upon consideration of the disclosure, may make modification and improvements within the spirit and scope of the invention. It is to be understood that the discussion of these specific embodiments in no way constitutes any limitation on the scope of the present invention, which extends to any and all alternative embodiments suitable for accomplishing the objectives of the present invention.

1. A gardening tool comprising:
a handle;
a cutting rake part attached to the handle, wherein the cutting rake part comprises a handle mounting portion and a surface engageable portion, wherein the surface engageable portion comprises a cutting edge and a dull protective portion;
wherein the cutting rake part is attached to the handle.

2. The gardening tool of claim 1, further comprising a gripping portion attached to the surface engageable portion.

3. The gardening tool of claim 1, wherein the surface engageable portion further comprises a gripping portion.

4. The gardening tool of claim 1, wherein the surface engageable portion has a triangular shape.

5. The gardening tool of claim 1, wherein the surface engageable portion has a plurality of V shaped teeth along one surface.

6. The gardening tool of claim 5, wherein cutting edge is on the inside of the V shaped teeth, and the dull protective portion is on the outside of the V shaped teeth.

7. A gardening tool comprising:
a handle attached to a cutting rake part, wherein the cutting rake part comprises a handle mounting portion adjacent to a surface engageable portion, wherein the surface engageable portion is triangular in shape, and wherein the surface engageable portion has a plurality of V shaped teeth along a surface of the surface engageable portion that engages the surface, wherein the V shaped teeth have a cutting portion on the inside of the V shaped teeth, and a dull protective portion on the outside of the V shaped teeth.

8. A gardening tool comprising:
a handle that is attached to a cutting rake part,
wherein the cutting rake part comprises a single molded part having a triangular mounting flange, a scooping portion attached to the mounting flange, a plurality of V-shaped teeth at distal end of the scooping part, a cutting blade that is mounted on V-shaped teeth so that a sharp edge of the blade is exposed between the plurality of V-shaped teeth.

9. The gardening tool of claim 8, wherein the cutting blade 26 is removable.

10. The gardening tool of claim 8, wherein an end of the V-shaped teeth is bent inward for safety and to avoid digging into the surface being weeded.

11. The gardening tool of claim 8, wherein the V-shaped teeth further comprise corrugated edges on the sides.
